(19) United States
(12) Patent Application Publication
(10) Pub. No.: US 2023/0370104 A1
(43) Pub. Date: Nov. 16, 2023

(54) PROCESSING ANTENNA SIGNALS USING MACHINE LEARNING NETWORKS WITH SELF-SUPERVISED LEARNING

(71) Applicant: DeepSig Inc., Arlington, VA (US)

(72) Inventors: Rajib Bhattacharjea, Atlanta, GA (US); Nathan West, Washington, DC (US)

(21) Appl. No.: 18/197,221

(22) Filed: May 15, 2023

Related U.S. Application Data
(60) Provisional application No. 63/341,852, filed on May 13, 2022.
(60) Provisional application No. 63/465,354, filed on May 10, 2023.

(51) Int. Cl. H04B 1/16; G06N 3/0455; G06N 3/0895

(52) U.S. Cl. CPC H04B 1/16; G06N 3/0455; G06N 3/0895

(57) ABSTRACT

A method for processing radio frequency (RF) signals is provided. The method includes receiving one or more RF signals from one or more antenna channels. The method includes obtaining, from the one or more RF signals, a plurality of unlabeled data samples. The method includes generating an input tensor representation of the plurality of data samples. The method includes pretraining a first machine learning network using the input tensor representation to obtain one or more embeddings. The method includes training a second machine learning network using the one or more embeddings. The second machine learning network is configured to perform one or more signal processing tasks. Also provided is a system having an antenna array and one or more processors.

### CROSS REFERENCE TO RELATED APPLICATIONS

This application claims the benefit of U.S. Provisional Patent Application No. 63/341,852, filed May 13, 2022, and U.S. Provisional Patent Application No. 63/465,354, filed May 10, 2023, the content of which are incorporated herein by reference.

### STATEMENT REGARDING FEDERALLY SPONSORED RESEARCH OR DEVELOPMENT

This invention was made with government support under U.S. Defense Advanced Research Projects Agency (DARPA) Agreement HR00112190100 awarded by the DARPA. The government has certain rights in the invention.

### BACKGROUND

This disclosure generally relates to processing antenna signals with machine learning.

Antennas are widely used to transmit and receive radio frequency (RF) signals over one or more channels. When multiple antennas are used by a receiving device (e.g., a mobile terminal), these are often formed into an antenna array to improve the reception performance. Each antenna member of an antenna array can be referred to as an antenna element. The received RF signals are typically characterized by attributes such as center frequencies, bandwidth, and modulation schemes. After receiving the RF signals, the receiving device may convert the RF signals to data samples (e.g., via an analog-to-digital converter (ADC)), transfer the data samples to a processing unit via a high-speed data interface, and perform downstream data processing tasks using the data samples.

### SUMMARY

In one aspect, a method for processing RF signals is provided. The method can be implemented in a system having an antenna array and one or more processors. The method includes receiving one or more RF signals from one or more antenna channels. The method includes obtaining, from the one or more RF signals, a plurality of unlabeled data samples. The method includes generating an input tensor representation of the plurality of data samples. The method includes pretraining a first machine learning network using the input tensor representation to obtain one or more embeddings. The method includes training a second machine learning network using the one or more embeddings. The second machine learning network is configured to perform one or more signal processing tasks.

In some implementations, to pretrain the first machine learning network using the input tensor representation, the method includes causing the first machine learning network to perform at least one of: tensor reconstruction, channel in-painting, time-channel ordering, de-noising, Simple framework for Contrastive Learning of Visual Representations (SimCLR), contrastive predictive coding, Barlow twins, or array covariance matrix estimation.

In some implementations, the tensor reconstruction includes modifying the input tensor representation to obtain a modified tensor representation, encoding the modified tensor representation using an encoder of the first machine learning network to obtain a latent representation, decoding the latent representation using a decoder of the first machine learning network to obtain a reconstructed tensor representation corresponding to the input tensor representation, calculating a loss function between the input tensor representation and the reconstructed tensor representation, making adjustments to one or more parameters of the encoder to reduce the loss function below a threshold value, and obtaining the one or more embeddings based on the adjustments.

In some implementations, to encode the modified tensor representation, the method includes obtaining a convolutional stem output based on the modified tensor representation, scaling the convolutional stem output by a pooling factor, and downsampling the scaled convolutional stem output based on a stride number.

In some implementations, the channel in-painting includes randomly setting one or more unlabeled data samples to zero.

In some implementations, the latent representation has less dimensionality than the input tensor representation.

In some implementations, the first machine learning network is pretrained using self-supervised learning.

In some implementations, the signal processing includes at least one of: beamforming weight detection, bandwidth regression, blind channel detection, signal detection from noise, joint signal detection, interference detection, signal classification, direction-of-arrival estimation, or channel estimation.

In some implementations, to generate the input tensor representation of the plurality of data samples, the method includes obtaining, from the plurality of data samples, a plurality of data frames in a time domain, performing a (STFT) on the plurality of RF data frames to obtain a joint time-and-frequency-domain representation of the plurality of data samples, and normalizing the joint time-and-frequency-domain representation of the plurality of data samples.

In some implementations, the input tensor representation includes at least one of: a first dimension representing the plurality of center frequencies, a second dimension representing the one or more antenna channels, a third dimension representing sampling times, or a fourth dimension representing one or more quadrature channels.

The details of one or more embodiments of the disclosure are set forth in the accompanying drawings and the description below. Other features and advantages of the invention will become apparent from the description, the drawings, and the claims.

### BRIEF DESCRIPTION OF THE DRAWINGS

FIG. 1 is a flow diagram illustrating an example of a process for processing RF signals, according to some implementations.

FIG. 2 is a block diagram illustrating an example of pretraining a machine learning network with self-supervised learning (SSL), according to some implementations.

FIG. 3 is a block diagram illustrating an example architecture of an encoder-decoder neural network, according to some implementations.

FIG. 4 is a block diagram illustrating an example of training a machine learning network using a pretrained encoder for a downstream task, according to some implementations.

FIG. 5 is a block diagram illustrating an example of deploying of a trained encoder-decoder network for a downstream task, according to some implementations.

FIG. 6 provides a spectrogram and a plot showing corresponding bandwidth regression target values, according to some implementations.

FIG. 7 is a flowchart illustrating an example of a method for processing RF signals, according to some implementations.

FIG. 8 illustrates an example of a wireless communication system in which some implementations can be used for processing RF signals.

FIG. 9 is a diagram illustrating an example of a computing system used for processing radio signals using a machine learning network, according to some implementations.

Like reference numbers and designations in the various drawings indicate like elements.

### DETAILED DESCRIPTION

Digital antenna arrays are used in modern wireless communications applications to receive RF signals having large data volume. For example, some digital antenna arrays can receive RF signals from software-defined radio (SDR) and provide data samples at each antenna element at tens or hundreds of megasamples per second, with each sample typically having 24 to 28 bits of precision and requiring 32 bits to transfer. Furthermore, the total data rate out of an antenna array can scale linearly with the bandwidth of the RF signals and with the number of antenna elements. This means that data samples from a wideband antenna array can rapidly saturate a high speed interface and computing resource as the bandwidth and the number of antenna elements increases. While beamforming can be used to reduce the data rate by forming a weighted sum of signals received by multiple antenna elements into a single signal, the operation of beamforming can lead to loss of information about signals from some directions. Accordingly, there is a need to reduce the volume of data samples from an antenna array without significantly losing content of the signals.

Within the received RF signals, there can be multiple degrees of spatial redundancy, spectral sparsity, and temporal structure, which can be exploited to reduce the volume of data samples output by an antenna array. For example, the received signal spectrum at each antenna element of an array can be similar, with each antenna element having a position-dependent spectral amplitude and phase offset relative to other antenna elements in the array. These offsets are usually structured functions of space and frequency and can be captured by a number of coefficients in a spatial Fourier representation, with each coefficient corresponding to a multipath direction-of-arrival. Similarly, in a typical terrestrial environment, a limited fraction of the spectrum may be occupied by actual RF signals, while a considerable portion of data samples output by the ADC may result from noise between the RF signals. Moreover, the types of RF signals that need to be represented can have structure that distinguishes them from random noise. Accordingly, the number bits needed to encode the data in the RF signals can be less than that actually output by the antenna array. Because of these characteristics of the RF signals received by antenna arrays, the data samples obtained from the RF signals have the potential of being compressed into representations (known as embeddings) that have fewer degrees of freedom and less dimensionality.

Machine learning networks, such as neural networks and Siamese networks used for signal encoding and/or decoding (encoder-decoder neural networks), can be used to process the data samples obtained from the RF signals. In order to train a machine learning network to perform a data processing task (referred to hereinafter as “downstream data processing task” or simply “downstream task”), labeled training data samples are needed. Labeling data samples (e.g., done manually by human operators) can consume significant labor and resources. It can be useful to have a mechanism for the machine learning network to leverage unlabeled training data. A network learning to compress unlabeled data is one way to use this kind of data in the training process.

As described in detail below, this disclosure provides techniques for pretraining a first machine learning network (also referred to as an embedding network) to perform a pretext task (e.g., a task that is related to the downstream data processing task) with unlabeled data samples. Applying self-supervised learning (SSL), the first machine learning network is used to output compressed representations of the RF signal distributions, and these output embeddings (e.g., information learned from the pretraining) are then provided to train a second machine learning network (also referred to as a downstream-task-specific network) to perform a task of downstream signal data processing. As discussed below, pretraining can improve the training performance by, e.g., expediting the training process and reducing the amount of training data samples to avoid overloading the high-speed interface. Because pretraining is based on SSL with little to no human involvement, having pretraining before training can reduce the effort and resources for processing the data from RF signals.

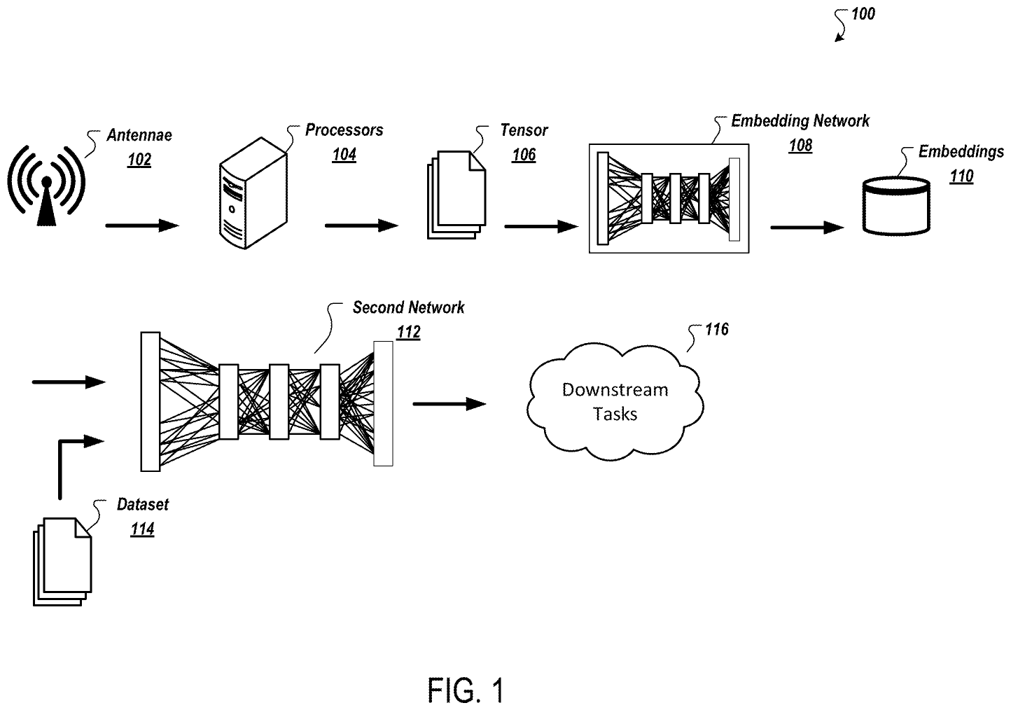

FIG. 1 is a flow diagram illustrating an example of a process 100 for processing RF signals, according to some implementations. The process 100 can be implemented in a RF signal receiver system having one or more computers coupled to one or more antennas.

In the process 100, one or more RF signals are received by one or more antennas 102, which can be an antenna array with multiple antenna elements. The one or more RF signals are received from one or more antenna channels, which can correspond to, e.g., one or more RF signal transmitters, one or more beams, one or more signal bandwidths, one or more carrier frequencies, or one or more modulation schemes, or any suitable combination of these.

The received RF signals are processed by one or more processors 104 to obtain a plurality of data samples from the one or more RF signals at a plurality of center frequencies. The processing can utilize one or more analog-to-digital converters (ADCs) to convert the RF signals to digital samples at a sampling rate. After the sampling process, each data sample can be identified by a combination of one or more variables, and the data samples can be grouped to form multiple training sets, whereas the grouping can be based on center frequency or other criteria depending on implementation. For example, in a scenario where RF signals are received from 4 antenna channels and subsequently sampled at 5,000,000 times, a data sample obtained from a given RF signal can be identified by a combination of: (i) the training set in which that data sample has been grouped; (ii) the antenna channel that receives the given RF signal; (iii) the time at which the data sample is obtained from the given RF signal; and (iv) the quadrature channel (either the in-phase component or the quadrature component) in case the RF signals are I/Q modulated. As such, each data sample can be represented as an element of a tensor space with a shape of [115, 4, 5,000,000, 2], whereas each of the variables in (i)-(iv) is a dimension of the tensor space. Depending on the configurations of the antennas and the processors, the data samples may be identified with more or fewer dimensions. Because these data samples are directly obtained from the RF signals without further processing, these data samples together are referred to as a raw dataset.

The one or more processors 104 generate an input tensor representation 106 of some or all of the data samples in the raw dataset. Depending on the pretext task, the complexity of the embedding network, the nature of the data samples, and/or the computing resources available for pretraining, the size and dimensionality (e.g., number of dimensions) of the input tensor representation 106 can vary. For example, for a pretext task that pretrains the embedding network to reconstruct spectrogram data with minimized error, the input tensor representation 106 can have a shape of [4, 65536, 2], meaning that a subset of the raw dataset is represented by the input tensor representation 106.

To obtain data samples for the input tensor representation 106, the one or more processors 104 can perform various data processing operations. As a non-limiting example, the one or more processors 104 pad the time dimension (5,000,000) with 46272 zeros to obtain a modified tensor space with a shape of [115, 4, 5,046,272, 2]. The one or more processors 104 then divide the time dimension (5,046,272) into 77 chunks of 65536 time samples each, resulting in a tensor with a shape of [115, 4, 77, 65536, 2]. Following these operations, the dimensions of (115) and (77) are merged (“collapsed”) to become a single dimension (8855). This creates a tensor with a shape of [8855, 4, 65536, 2]. In doing so, the one or more processors 104 has obtained 8855 tensor items as input tensor representation 106, with each tensor item having a shape of [4, 65536, 2] to identify data samples corresponding to 4 antenna channels, 65536 sampling times, and 2 quadrature channels. Each tensor item here can be considered a frame of the raw dataset.

In some implementations, the input tensor representation 106 undergoes further pre-processing of compression and dimensionality reduction. An advantage of doing so is to facilitate the learning of the process of the embedding network 108. For example, a frame with a shape of [4, 65536, 2] can be pre-processed into a joint time-frequency representation, e.g., via a short-time Fourier transform (STFT), that is suitable for detecting data information from noise. To do so, the trailing dimension of 2 (i.e., the dimension that represents a quadrature channel) is first absorbed into the time dimension by converting the tensor representation to be complex with real and imaginary parts. This results in a tensor with a shape of [4, 65536]. The time dimension is then reshaped into two dimensions with 32 time chunks and 2048 continuous time steps, resulting in a tensor of shape [4, 32, 2048]. After applying a Hann window function along the time dimension (2048), a discrete Fourier transform (DFT) is performed on the time dimension, resulting in 4-channel Hann-windowed STFTs with 32 time chunks and 2048 frequency bins, e.g., a complex tensor having a shape of [4, 32, 2048]. The real and imaginary parts of the complex tensor are separated back into a new trailing dimension with a size of 2, giving a tensor a shape of [4, 32, 2048, 2] with all entries being real. The trailing quadrature dimension (2) is then merged with the dimension of antenna channels (4), resulting in a set of 8-channel training examples, each of a shape of [8, 32, 2048]. Each training example is then normalized (e.g., standardized) by subtracting the mean of the example set and dividing by the standard deviation of the example set. After the normalization, the set of training examples have zero mean and unit variance across the channel (8), time (32), and frequency (2048) dimensions.

It is noted that the above-described operations may vary depending on applications. It is also noted that not all operations are required for all implementations. For example, in some scenarios where the raw dataset has relatively fewer data samples, it is possible to omit the pre-processing operations.

The items of the input tensor representation 106 can be used to pretrain an embedding network 108, which can be an encoder-decoder neural network or a Siamese network. While the below description is primarily based on scenarios that use encoder-decoder neural networks, other types of machine networks for pretraining and/or training can be used similarly. The data samples in the input tensor representation 106 are unlabeled, meaning that the embedding network 108 executes SSL through the pretraining process with little or no human intervention.

Through the pretraining process, the one or more processors 104 obtain one or more embedding network parameters, referred to as embeddings hereinafter. These embeddings, labeled as embeddings 110 in FIG. 1, can be in the form of one or more vectors and can include weights or other parameters that configure the embedding network 108. The one or more embeddings 110 describe information that the embedding network 108 has learned from the pretraining process. For example, the embedding network 108 can learn, from the pretraining process, that a target outcome (which can depend on the specific downstream task) is realized by configuring the embedding network 108 with a certain set of weights. In this manner, the embedding network 108 can provide the set of weights as the one or more embeddings 110, which can be further applied (e.g., loaded) to configure and train a second machine learning network 112 for performing downstream tasks 116 related to the pretext task. For example, embeddings learned from a spectrogram data reconstruction task can be applied to trainings for beamforming weight detection, bandwidth regression, blind channel detection, signal detection from noise, joint signal detection, interference detection, signal classification, direction-of-arrival or angle-of-arrival estimation, channel estimation, or other tasks of processing the one or more RF signals. Consistent with this, in some implementations, the trained embedding network 108, configured with the learned embeddings, can be used as part of the second machine learning network 112.

The training of the second machine learning network 112 can be partially or fully supervised. For example, the second machine learning network 112 can receive an input dataset 114, which can be derived from the raw dataset or obtained from other sources. Some or all of data samples in the input dataset 114 can be labeled, e.g., by manual input or by automated software/hardware tools. Labeling a data sample can help the second machine learning network 112 track the data sample, compare the output of the second machine learning network 112 with a target output, and make adjustments to improve performance. After training, the second machine learning network 112 can be deployed to perform one or more of the downstream tasks 116.

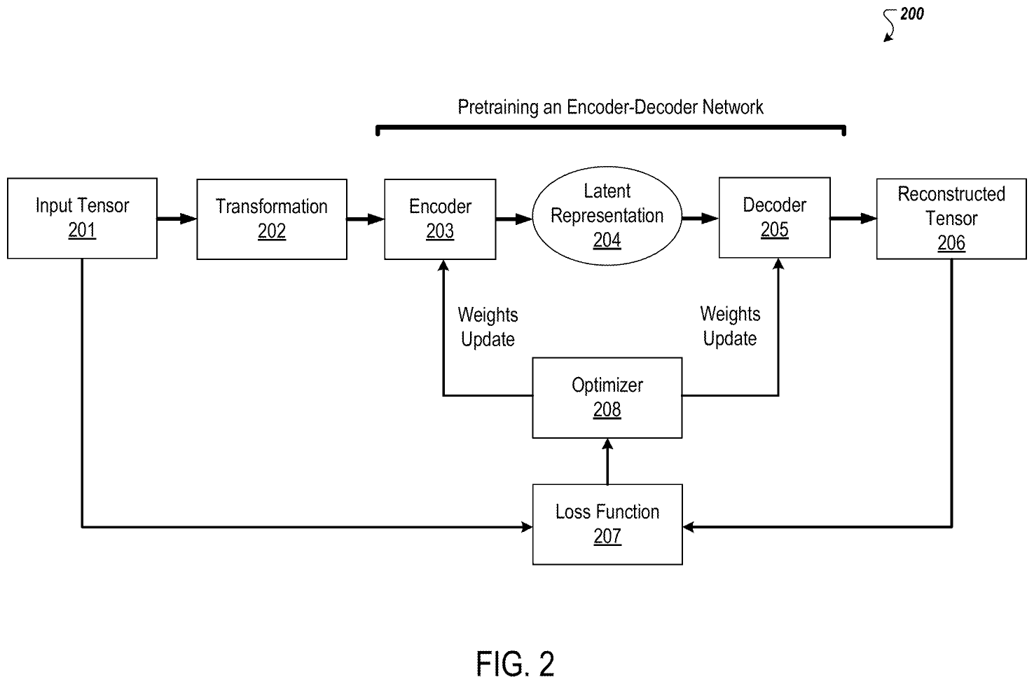

FIG. 2 is a block diagram 200 illustrating an example of pretraining a machine learning network with SSL, according to some implementations. The pretraining illustrated by the block diagram 200 can be similar to one or more operations of process 100 in FIG. 1. In particular, in some implementations, the pretraining illustrated by block diagram 200 is performed on an encoder-decoder neural network, formed by an encoder 203 and a decoder 205, which is an example of the embedding network 108 of FIG. 1.

The pretext task in the example of block diagram 200 is for the encoder 203 to create a latent representation 204 from a modified (e.g., noise-corrupted) version of the input tensor 201, with the latent representation 204 having less dimensionality than the input tensor 201. Ideally, the pretraining should enable the encoder 203 to create the latent representation 204 as if no modifications were made to the input tensor 201. Besides the pretext task described with reference to FIG. 2, other pretext tasks that can be used for pretraining include channel in-painting (e.g., channel masking operations that uniformly-randomly select data for one antenna channel per training example and set the data to all zeros), time-channel ordering, de-noising, Simple framework for Contrastive Learning of Visual Representations (SimCLR), contrastive predictive coding, Barlow twins, or array covariance matrix estimation. The below description of pretraining based the pretext task is for illustrative purpose only. Furthermore, the latent representation 204 in other implementations can have the same dimensionality as the input tensor 201 or greater dimensionality than the input tensor 201.

In more detail, the input tensor 201 undergoes transformation 202, which modifies some data samples (e.g., corrupt the data samples to simulate noise or interference) represented by the input tensor 201. The modified data samples, forming a modified tensor, are input to the encoder 203, which creates the latent representation 204. The latent representation 204 is then decoded by a decoder 205 to output a reconstructed tensor 206. The input tensor 201 and the reconstructed tensor 206 are then compared to obtain a loss function 207, which describes the difference between the input tensor 201 and the reconstructed tensor 206. The difference is caused by the transformation 202, which modifies the input tensor 201. Specifically, the modification to the input tensor 201 is propagated to the latent representation 204 through the encoding process and further propagated to the reconstructed tensor 206 through the decoding process.

The loss function 207 can be represented by, e.g., a mean-squared magnitude of difference between the reconstructed tensor 206 and the corresponding input tensor 201 for a set of training examples. For example, for each training data sample (represented as an input tensor) in a training set, the difference between the input tensor and the reconstructed tensor is calculated. For the entire training set, all of the differences are mean-squared to obtain the loss function 207. In some implementations, the pretraining and the calculation of the loss function 207 is based on the Adam variant of stochastic gradient descent.

The loss function 207 is input to an optimizer 208 that adjusts the weights of the encoder 203 and the decoder 205. The process repeats and the weights are updated until the loss function is sufficiently small, e.g., lower than a threshold. This would indicate that the encoder-decoder neural network has learned information to conduct a mapping from the modified input data samples to a latent representation that includes enough information for reconstructing the unmodified input data samples with an acceptable level of fidelity. The information learned from the pretraining process, including the weights applied to the encoder 203, can be considered embeddings, such as the one or more embeddings 110 of FIG. 1.

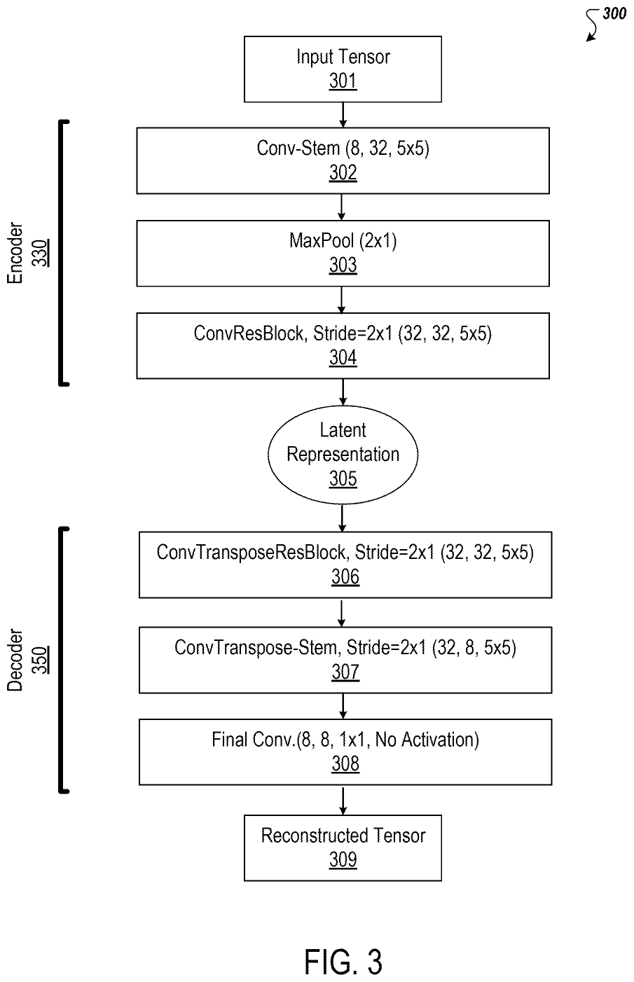

FIG. 3 is a block diagram illustrating an example architecture 300 of an encoder-decoder neural network, according to some implementations. The architecture 300 has an encoder 330 that converts an input tensor 301 to a latent representation 305 and a decoder 350 that reconstructs the input tensor 301 and outputs a reconstructed tensor 309 based on the latent representation 305. In some implementations, the architecture 300 corresponds to the encoder-decoder neural network of FIG. 2. For example, in such implementations, the encoder 330 is similar to the encoder 203, the decoder 350 is similar to decoder 205, the input tensor 301 is similar to the input tensor 201 after undergoing the transformation 202, the reconstructed tensor 309 is similar to the reconstructed tensor 206, and the latent representation 305 is similar to the latent representation 204. The architecture 300 is illustrated as receiving input data with 8 channels, each being the real or imaginary part of a windowed STFT of a raw data set with 65536 time-domain samples. Further, the architecture 300 is illustrated with a kernel size of 5-by-5 (5×5).

The architecture 300 is based on a convolutional residual block structure with squeeze-and-excitation with a squeeze reduction ratio of 8. The encoder 330 first increases the channel count of the input data from 8 to 32 using a convolutional stem 302, while keeping the time and frequency resolutions (e.g., values of the dimensions) unchanged. The encoder 330 then uses a pooling layer 303 to scale (e.g., reduce) the STFT time resolution by a pooling factor of 2. Further, the encoder 330 uses one or more (e.g., two) layers 304 of strided convolution to downsample the tensor output by the pooling layer 303, arriving at the latent representation 305.

The decoder 350 operates in a transposed fashion such that strided layers perform an upsampling operation in the STFT space. That is, the operations performed by blocks 306-308 of the decoder 350 can be considered reversed operations of those performed by blocks 302-304 of the encoder 301. With these operations, the architecture 300 obtains a reconstructed tensor 309.

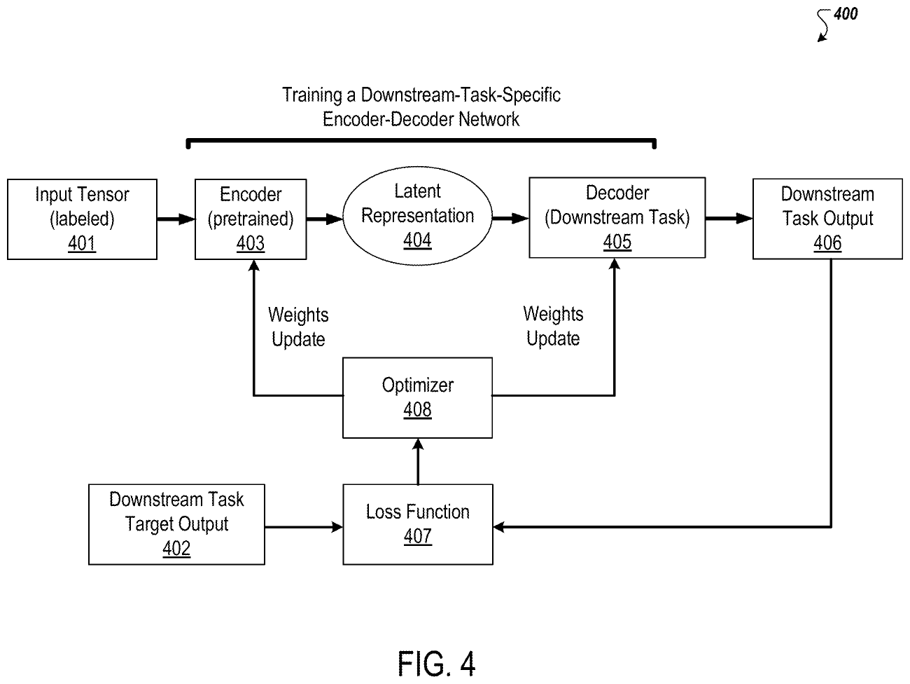

As discussed earlier, the embedding network weights learned from the pretraining process can be applied to a downstream-task-specific network to train the downstream-task-specific network for performing the downstream data processing task. The training of the downstream-task-specific network is described below with reference to FIG. 4.

FIG. 4 is a block diagram 400 illustrating an example of training a machine learning network using a pretrained encoder for a downstream task, according to some implementations. The training illustrated in FIG. 4 can be similar to one or more operations of process 100 in FIG. 1.

The training illustrated in FIG. 4 utilizes the embeddings learned from pretraining, such as the embedding network weights learned from the pretraining described with reference to FIG. 2. In such a scenario, the downstream-task-specific network can be formed using a pretrained encoder 403 that is similar to the encoder 203 in FIG. 2 and an untrained decoder 405 that is configured to perform the downstream task. At the beginning the training, the encoder 403 can be loaded with the embedding network weights learned during pretraining. In other words, the encoder 403 can be initialized with configurations according to the learned embedding network weights. As such, the information learned by the embedding network is transferred to the downstream-task-specific network. As described previously, the embeddings can be in the form of one or more vectors and can include particular parameter values (e.g., weights) that can be used to configure the embedding network to achieve a target outcome. On the other hand, the decoder 405 can randomly initialized, or can be initialized with configurations that are specific to the downstream task.

The encoder 403 is provided with an input tensor 401 as a representation of training data samples. The input tensor 401 can be obtained from labeled data samples of a smaller size than the input data sensor 201 of FIG. 2 and can be structured different from the input tensor 201. Similar to the operations described with reference to FIG. 2, the encoder 403 generates a latent representation 404 of the input tensor 401, which is then input to the decoder 405.

Different from the decoder 205 in FIG. 2 that is configured to perform the pretext task, the decoder 405 in FIG. 4 is configured to perform the downstream task and provide a downstream task output 406. Because the downstream task may not involve reconstructing the input tensor 401, the downstream task output 406 may be in a form that is not directly comparable to the input tensor 401 for the purpose of calculating a loss function 407. Accordingly, a downstream task target output 402, which is in the same form as the downstream task output 406, is used to calculate the loss function 407. For each instance of the input tensor 401, the corresponding downstream task target output 402 can be obtained to describe the target output of the decoder 405. Accordingly, the loss function 407 obtained from comparing the downstream task output 406 with the downstream task target output 402 indicates the difference between the downstream task output 406 and the target output. The calculation of the loss function 407 in the training process can be similar to the calculation in the pretraining process, as described above with reference to FIG. 2.

With the loss function 407 calculated, the optimizer 408 operates to adjust the weights of the encoder 403 and the decoder 405. Similar to the weight adjustment described with reference to FIG. 2, the adjustment by the optimizer 408 repeats until the loss function is sufficiently small, e.g., the difference between the downstream task output 406 from the downstream task target output 402 is lower than a specified threshold value, which indicates that the decoder 405 is adequately trained for performing the downstream task.

In the training process, the input data samples can be labeled, e.g., with identifying information corresponding to each data sample, which propagates though the encoding and decoding processes and is reproduced in downstream task output 406. The downstream task target output 402 can also have labels that identify the data samples. Labeling is helpful for matching the output of the decoder 405 with a corresponding target output, which ensures accuracy in the computation of the loss function 407. With the labeling, the training of the downstream-task-specific network can be considered supervised learning (or semi-supervised learning), as opposed to SSL in the pretraining described with reference to FIG. 2.

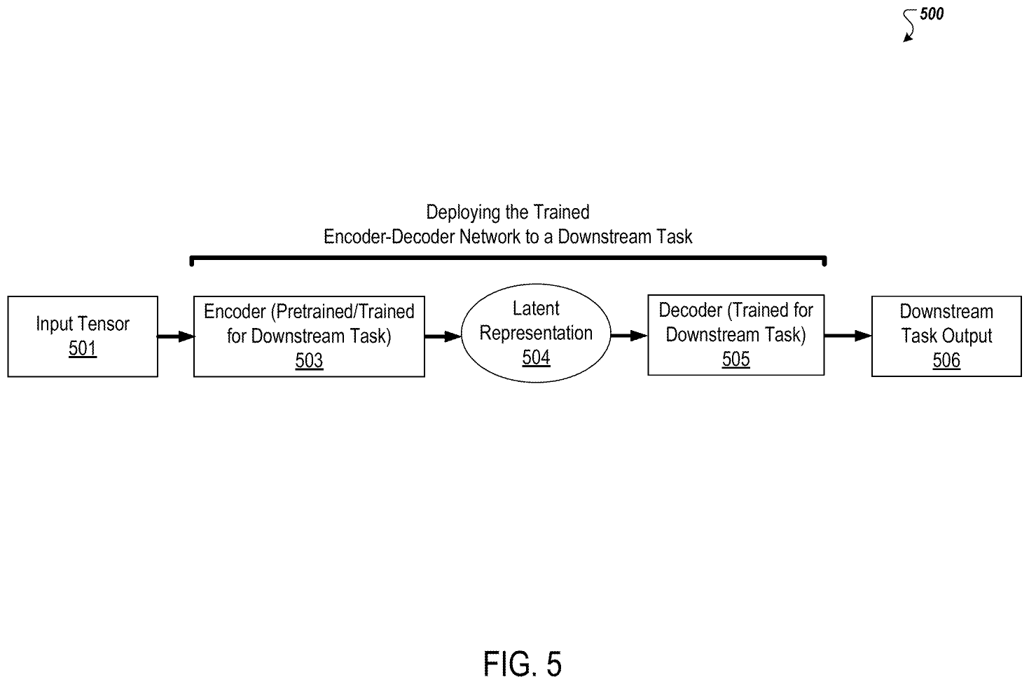

FIG. 5 is a block diagram 500 illustrating an example of deploying of a trained encoder-decoder network for a downstream task, according to some implementations. The deployment illustrated in the block diagram 500 can be similar to one or more operations of process 100 in FIG. 1. For example, the deployment can be performing the one or more downstream tasks 116 of FIG. 1. Block diagram 500 illustrates a scenario in which the deployed encoder-decoder network, formed by an encoder 503 and a decoder 505, is trained according to the process described with reference to FIG. 4. In such a scenario, the encoder 503 and the decoder 505 are similar to the encoder 403 and the decoder 405, and the downstream task 506 for which the machine learning network is deployed is the similar to that for which the machine learning network is trained. In other scenarios or implementations, the encoder 503 can be deployed after pretraining, e.g., without undergoing the training process.

In the example deployment, the input tensor 501 can represent data samples obtained from the raw dataset and can additionally or alternatively represent other data samples obtained from other RF signals. Because both the encoder 503 and the decoder 505 are configured with parameters (e.g., weights of the encoder and decoder machine learning networks) learned from the pretraining and/or training process, the downstream task output 506 that is obtained from the deployment has values that are close to a target downstream task output (e.g., difference between values of the downstream task output 506 and the target output are within a specific threshold value).

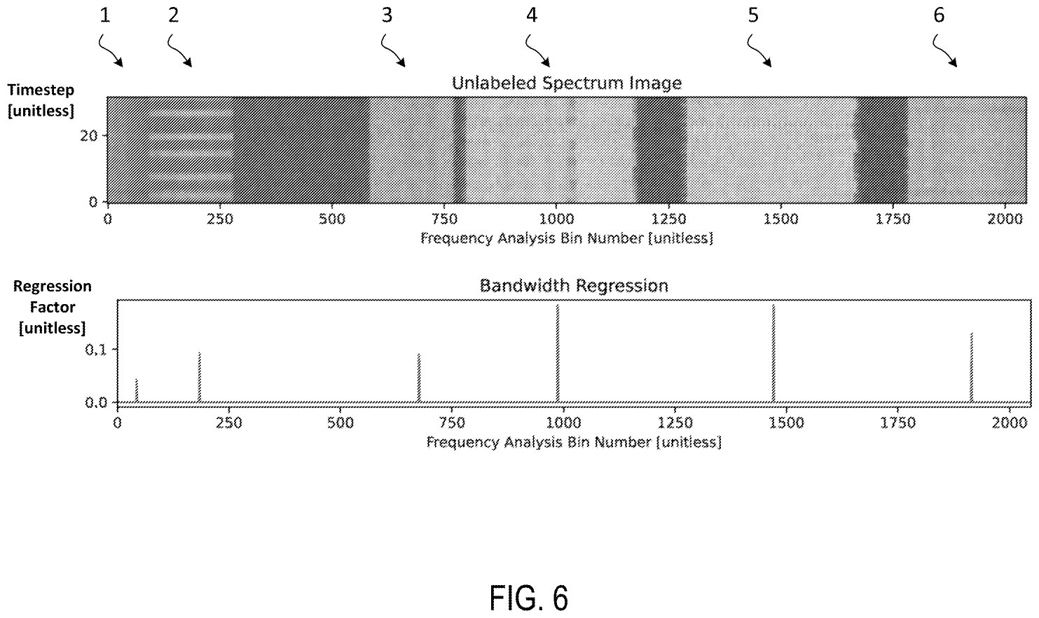

As an example, a downstream task can be signal bandwidth regression, which involves mapping the STFT outcome of RF signals to a function of frequency bins, with the function taking a value proportional to the signal bandwidth for a bin at the center frequency and a value of zero everywhere else in the frequency domain. An example of signal bandwidth regression performed in the scenario of FIGS. 1-5 is described below with reference to FIG. 6.

FIG. 6 provides a spectrogram (upper part) and a plot (lower part) showing corresponding bandwidth regression target values, according to some implementations. The spectrogram is generated from taking a chunk of 65536 RF samples from one antenna channel and calculating a log-magnitude of the Hann-windowed and non-overlapping STFT on 2048 analysis bins. The operations of obtaining the RF samples and generating the spectrogram can be similar to the operations described above with reference to FIG. 1. The spectrogram shows six signals, labeled 1-6 in the figure, distributed over the frequency bins with varying power levels (as indicated by the different color intensities) and varying bandwidths (as indicated by the different widths across the horizontal axis). Correspondingly, the lower plot shows six non-zero frequency bins. The locations of the six non-zero frequency bins shown in the lower plot can be the target output of the downstream task of signal bandwidth regression (corresponding to the one antenna channel), for which a downstream-task-specific network can be trained. Although the illustration of FIG. 6 is based on a single channel scenario, the task of signal bandwidth regression can be applied to data samples from multiple channels. Generally speaking, the downstream-task-specific network can be trained to map multi-channel complex STFT data samples (e.g., represented by a tensor) in a spectrogram to the frequency bins in a plot similar to the lower plot of FIG. 6. Pretraining can expedite the training process by, e.g., causing the loss function to converge at a faster speed than in a training process without pretraining.

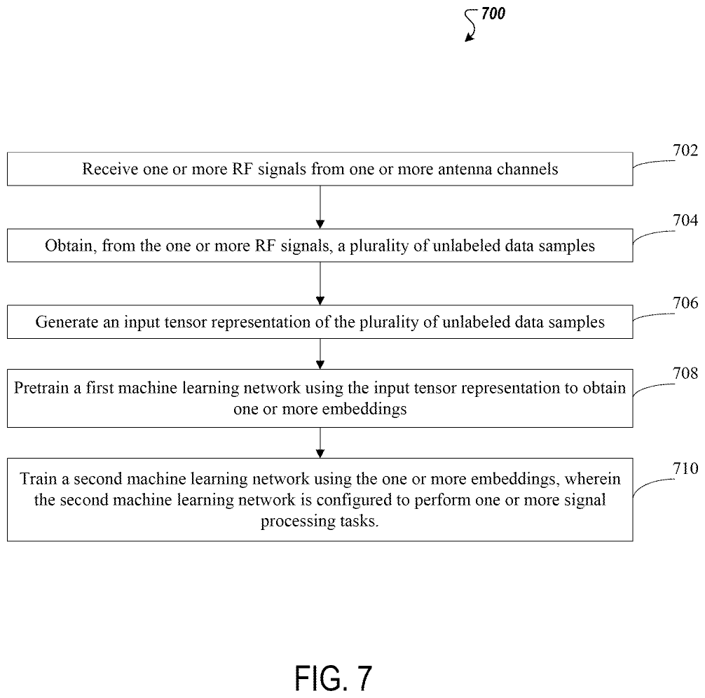

FIG. 7 is a flowchart illustrating an example of a method 700 for processing RF signals, according to some implementations. For clarity of presentation, the description that follows generally describes the method 700 in the context of the other figures in this description. For example, the method 700 can be performed similar to the process 100 of FIG. 1. It will be understood that the method 700 can be performed, for example, by any suitable system, environment, software, hardware, or a combination of systems, environments, software, and hardware, as appropriate. In some implementations, various steps of the method 700 can be run in parallel, in combination, in loops, or in any order.

At 702, the method 700 involves receiving one or more RF signals from one or more antenna channels. The one or more RF signals can be obtained, e.g., by the one or more antennas 102 of FIG. 1.

At 704, the method 700 involves obtaining, from the one or more RF signals, a plurality of unlabeled data samples. The RF signals can be received at a plurality of center frequencies.

At 706, the method 700 involves generating an input tensor representation of the plurality of unlabeled data samples. The input tensor representation can be similar to the input tensor representation 106 of FIG. 1 or the input tensor representation 201 of FIG. 2.

At 708, the method 700 involves pretraining a first machine learning network using the input tensor representation to obtain one or more embeddings. The first machine learning network can be similar to the embedding network 108 of FIG. 1 or the embedding network formed by the encoder 203 and the decoder 205 of FIG. 2. The one or more embeddings can be similar to or can include the weights obtained from the pretraining described with reference to FIG. 2.

At 710, the method 700 involves training a second machine learning network using the one or more embeddings. The second machine learning network can be similar to the second machine learning network 112 of FIG. 1 or the machine learning network formed by the encoder 403 and the decoder 405 of FIG. 4. The second machine learning network is configured to perform one or more signal processing tasks, such as the downstream tasks 116 of FIG. 1.

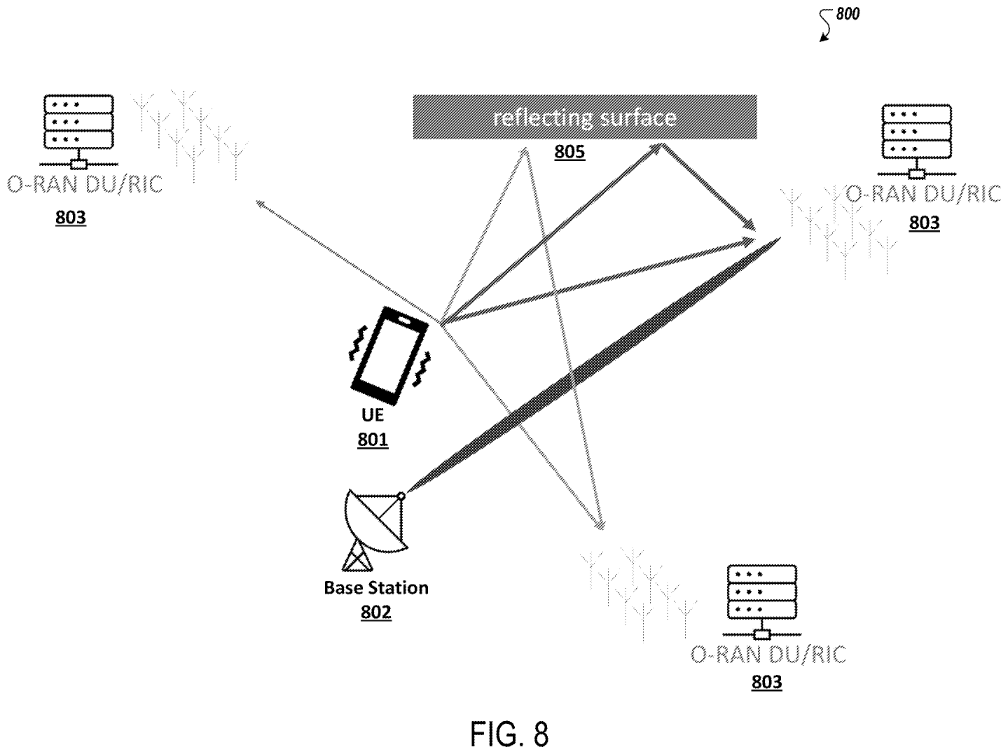

FIG. 8 illustrates an example of a wireless communication system 800 in which some implementations can be used for processing RF signals. The wireless communication system 800 can be an open radio access network (O-RAN) supporting massive multiple-input-multiple-output (mMIMO).

In the wireless communication system 800, a user equipment (UE) 801 communicates with a base station 802 via a plurality of O-RAN distributed units (DUs) or RAN intelligent controllers (RICs) 803. Each of the O-RAN DUs/RICs 803 has an array of antennas that receive RF signals from the UE 801 either directly or after reflection by reflecting surface 805. In such communication, the UE 801 frequently transmits sounding reference signals (SRSs) to the base station to provide updated information about the channels between the UE 801 and the O-RAN DUs/RICs 803. These updates can help the base station 802 to adjust beamforming taps (e.g., weight parameters).

The wireless communication system 800 can be used as a multi-static radar, for sensing applications, or for digital twins. Depending on the application, the O-RAN can perform one or more downstream tasks to process the signals received by the arrays of the DUs/RICs 803 and use a machine learning network to facilitate the performance of the downstream tasks. The machine learning network can be pretrained/trained according to the operations described previously with reference to FIGS. 1-7.

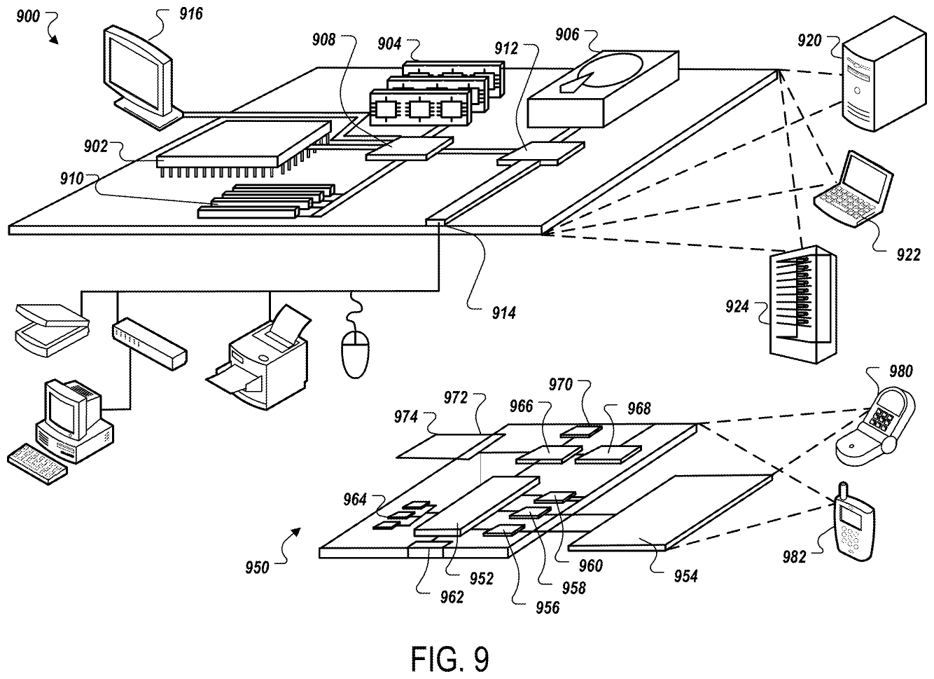

FIG. 9 is a diagram illustrating an example of a computing system used for processing RF signals using a machine learning network. The computing system includes computing device 900 and a mobile computing device 950 that can be used to implement the techniques described herein. For example, one or more operations of the process 100, such as the pretraining and training of machine learning networks 108 and 112, can be performed by one or more processors of the computing device 900 or the mobile computing device 950.

The computing device 900 is intended to represent various forms of digital computers, such as laptops, desktops, workstations, personal digital assistants, servers, blade servers, mainframes, and other appropriate computers. The mobile computing device 950 is intended to represent various forms of mobile devices, such as personal digital assistants, cellular telephones, smart-phones, mobile embedded radio systems, radio diagnostic computing devices, and other similar computing devices. The components shown here, their connections and relationships, and their functions, are meant to be examples only, and are not meant to be limiting.

The computing device 900 includes a processor 902, a memory 904, a storage device 906, a high-speed interface 908 connecting to the memory 904 and multiple high-speed expansion ports 910, and a low-speed interface 912 connecting to a low-speed expansion port 914 and the storage device 906. Each of the processor 902, the memory 904, the storage device 906, the high-speed interface 908, the high-speed expansion ports 910, and the low-speed interface 912, are interconnected using various busses, and may be mounted on a common motherboard or in other manners as appropriate. The processor 902 can process instructions for execution within the computing device 900, including instructions stored in the memory 904 or on the storage device 906 to display graphical information for a GUI on an external input/output device, such as a display 916 coupled to the high-speed interface 908. In other implementations, multiple processors and/or multiple buses may be used, as appropriate, along with multiple memories and types of memory. In addition, multiple computing devices may be connected, with each device providing portions of the operations (e.g., as a server bank, a group of blade servers, or a multi-processor system). In some implementations, the processor 902 is a single threaded processor. In some implementations, the processor 902 is a multi-threaded processor. In some implementations, the processor 902 is a quantum computer.

The memory 904 stores information within the computing device 900. In some implementations, the memory 904 is a volatile memory unit or units. In some implementations, the memory 904 is a non-volatile memory unit or units. The memory 904 may also be another form of computer-readable medium, such as a magnetic or optical disk.

The storage device 906 is capable of providing mass storage for the computing device 900. In some implementations, the storage device 906 may be or include a computer-readable medium, such as a floppy disk device, a hard disk device, an optical disk device, or a tape device, a flash memory or other similar solid-state memory device, or an array of devices, including devices in a storage area network or other configurations. Instructions can be stored in an information carrier. The instructions, when executed by one or more processing devices (for example, processor 902), perform one or more methods, such as those described above. The instructions can also be stored by one or more storage devices such as computer- or machine readable mediums (for example, the memory 904, the storage device 906, or memory on the processor 902). The high-speed interface 908 manages bandwidth-intensive operations for the computing device 900, while the low-speed interface 912 manages lower bandwidth-intensive operations. Such allocation of functions is an example only. In some implementations, the high speed interface 908 is coupled to the memory 904, the display 916 (e.g., through a graphics processor or accelerator), and to the high-speed expansion ports 910, which may accept various expansion cards (not shown). In the implementation, the low-speed interface 912 is coupled to the storage device 906 and the low-speed expansion port 914. The low-speed expansion port 914, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 900 may be implemented in a number of different forms, as shown in the figure. For example, it may be implemented as a standard server 920, or multiple times in a group of such servers. In addition, it may be implemented in a personal computer such as a laptop computer 922. It may also be implemented as part of a rack server system 924. Alternatively, components from the computing device 900 may be combined with other components in a mobile device, such as a mobile computing device 950. Each of such devices may include one or more of the computing device 900 and the mobile computing device 950, and an entire system may be made up of multiple computing devices communicating with each other.

The mobile computing device 950 includes a processor 952, a memory 964, an input/output device such as a display 954, a communication interface 966, and a transceiver 968, among other components. The mobile computing device 950 may also be provided with a storage device, such as a micro-drive or other device, to provide additional storage. Each of the processor 952, the memory 964, the display 954, the communication interface 966, and the transceiver 968, are interconnected using various buses, and several of the components may be mounted on a common motherboard or in other manners as appropriate.

The processor 952 can execute instructions within the mobile computing device 950, including instructions stored in the memory 964. The processor 952 may be implemented as a chipset of chips that include separate and multiple analog and digital processors. The processor 952 may provide, for example, for coordination of the other components of the mobile computing device 950, such as control of user interfaces, applications run by the mobile computing device 950, and wireless communication by the mobile computing device 950.

The processor 952 may communicate with a user through a control interface 958 and a display interface 956 coupled to the display 954. The display 954 may be, for example, a TFT (Thin-Film-Transistor Liquid Crystal Display) display or an OLED (Organic Light Emitting Diode) display, or other appropriate display technology. The display interface 956 may include appropriate circuitry for driving the display 954 to present graphical and other information to a user. The control interface 958 may receive commands from a user and convert them for submission to the processor 952. In addition, an external interface 962 may provide communication with the processor 952, so as to enable near area communication of the mobile computing device 950 with other devices. The external interface 962 may provide, for example, for wired communication in some implementations, or for wireless communication in other implementations, and multiple interfaces may also be used.

The memory 964 stores information within the mobile computing device 950. The memory 964 can be implemented as one or more of a computer-readable medium or media, a volatile memory unit or units, or a non-volatile memory unit or units. An expansion memory 974 may also be provided and connected to the mobile computing device 950 through an expansion interface 972, which may include, for example, a SIMM (Single In Line Memory Module) card interface. The expansion memory 974 may provide extra storage space for the mobile computing device 950, or may also store applications or other information for the mobile computing device 950. Specifically, the expansion memory 974 may include instructions to carry out or supplement the processes described above, and may include secure information also. Thus, for example, the expansion memory 974 may be provide as a security module for the mobile computing device 950, and may be programmed with instructions that permit secure use of the mobile computing device 950. In addition, secure applications may be provided via the SIMM cards, along with additional information, such as placing identifying information on the SIMM card in a non-hackable manner.

The memory may include, for example, flash memory and/or NVRAM memory (nonvolatile random access memory), as discussed below. In some implementations, instructions are stored in an information carrier such that the instructions, when executed by one or more processing devices (for example, processor 952), perform one or more methods, such as those described above. The instructions can also be stored by one or more storage devices, such as one or more computer- or machine-readable mediums (for example, the memory 964, the expansion memory 974, or memory on the processor 952). In some implementations, the instructions can be received in a propagated signal, for example, over the transceiver 968 or the external interface 962.

The mobile computing device 950 may communicate wirelessly through the communication interface 966, which may include digital signal processing circuitry in some cases. The communication interface 966 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), LTE, 5G/6G cellular, among others. Such communication may occur, for example, through the transceiver 968 using a radio frequency. In addition, short-range communication may occur, such as using a Bluetooth, Wi-Fi, or other such transceiver (not shown). In addition, a GPS (Global Positioning System) receiver module 970 may provide additional navigation- and location-related wireless data to the mobile computing device 950, which may be used as appropriate by applications running on the mobile computing device 950.

The mobile computing device 950 may also communicate audibly using an audio codec 960, which may receive spoken information from a user and convert it to usable digital information. The audio codec 960 may likewise generate audible sound for a user, such as through a speaker, e.g., in a handset of the mobile computing device 950. Such sound may include sound from voice telephone calls, may include recorded sound (e.g., voice messages, music files, among others) and may also include sound generated by applications operating on the mobile computing device 950.

The mobile computing device 950 may be implemented in a number of different forms, as shown in the figure. For example, it may be implemented as a cellular telephone 980. It may also be implemented as part of a smart-phone 982, personal digital assistant, or other similar mobile device.

A number of implementations have been described. Nevertheless, it will be understood that various modifications may be made without departing from the spirit and scope of the disclosure. For example, various forms of the flows shown above may be used, with steps re-ordered, added, or removed.

Embodiments of the invention and all of the functional operations described in this specification can be implemented in digital electronic circuitry, or in computer software, firmware, or hardware, including the structures disclosed in this specification and their structural equivalents, or in combinations of one or more of them. Embodiments of the invention can be implemented as one or more computer program products, e.g., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the invention have been described. Other embodiments are within the scope of the following claims. For example, the steps recited in the claims can be performed in a different order and still achieve desirable results.

What is claimed is:

1. A method for processing radio frequency (RF) signals, the method comprising:
receiving one or more RF signals from one or more antenna channels;
obtaining, from the one or more RF signals, a plurality of unlabeled data samples;
generating an input tensor representation of the plurality of unlabeled data samples;
pretraining a first machine learning network using the input tensor representation to obtain one or more embeddings; and
training a second machine learning network using the one or more embeddings,
wherein the second machine learning network is configured to perform one or more signal processing tasks.

2. The method of claim 1, wherein pretraining the first machine learning network using the input tensor representation comprises causing the first machine learning network to perform at least one of:
tensor reconstruction, channel in-painting, time-channel ordering, de-noising, Simple framework for Contrastive Learning of Visual Representations (SimCLR), contrastive predictive coding, Barlow twins, or array covariance matrix estimation.

3. The method of claim 2, wherein the tensor reconstruction comprises:
modifying the input tensor representation to obtain a modified tensor representation;
encoding the modified tensor representation using an encoder of the first machine learning network to obtain a latent representation;
decoding the latent representation using a decoder of the first machine learning network to obtain a reconstructed tensor representation corresponding to the input tensor representation;
calculating a loss function between the input tensor representation and the reconstructed tensor representation;
making adjustments to one or more parameters of the encoder to reduce the loss function below a threshold value; and
obtaining the one or more embeddings based on the adjustments.

4. The method of claim 3, wherein encoding the modified tensor representation comprises:
obtaining a convolutional stem output based on the modified tensor representation;
scaling the convolutional stem output by a pooling factor; and
downsampling the scaled convolutional stem output based on a stride number.

5. The method of claim 2, wherein the channel in-painting comprises randomly setting one or more unlabeled data samples to zero.

6. The method of claim 1, wherein the latent representation has less dimensionality than the input tensor representation.

7. The method of claim 1, wherein the first machine learning network is pretrained using self-supervised learning.

8. The method of claim 1, wherein the one or more signal processing tasks comprise at least one of:
beamforming weight detection,
bandwidth regression,
blind channel detection,
signal detection from noise,
joint signal detection,
interference detection,
signal classification,
direction-of-arrival estimation, or
channel estimation.

9. The method of claim 1, wherein generating the input tensor representation of the plurality of data samples comprises:
obtaining, from the plurality of data samples, a plurality of data frames in a time domain;
performing a short-time Fourier transform (STFT) on the plurality of RF data frames to obtain a joint time-and-frequency-domain representation of the plurality of data samples; and
normalizing the joint time-and-frequency-domain representation of the plurality of data samples.

10. The method of claim 1, wherein the input tensor representation comprises at least one of:
a first dimension representing grouping of the plurality of unlabeled data samples,
a second dimension representing the one or more antenna channels,
a third dimension representing sampling times, or
a fourth dimension representing one or more quadrature channels.

11. A system for processing radio frequency (RF) signals, the system processing:
an antenna array comprising a plurality of antenna elements, the antenna array configured to receive one or more RF signals from one or more communication channels corresponding to the plurality of antenna elements; and
one or more processors configured to perform operations comprising:
obtaining, from the one or more RF signals, a plurality of unlabeled data samples;
generating an input tensor representation of the plurality of data samples;
pretraining a first machine learning network using the input tensor representation to obtain one or more embeddings; and
training a second machine learning network using the one or more embeddings,
wherein the second machine learning network is configured to perform one or more signal processing tasks.

12. The system of claim 11, wherein pretraining the first machine learning network using the input tensor representation comprises causing the first machine learning network to perform at least one of:
tensor reconstruction, channel in-painting, time-channel ordering, de-noising, Simple framework for Contrastive Learning of Visual Representations (SimCLR), contrastive predictive coding, Barlow twins, or array covariance matrix estimation.

13. The system of claim 12, wherein the tensor reconstruction comprises:
modifying the input tensor representation to obtain a modified tensor representation;
encoding the modified tensor representation using an encoder of the first machine learning network to obtain a latent representation;
decoding the latent representation using a decoder of the first machine learning network to obtain a reconstructed tensor representation corresponding to the input tensor representation;
calculating a loss function between the input tensor representation and the reconstructed tensor representation;
making adjustments to one or more parameters of the encoder to reduce the loss function below a threshold value; and
obtaining the one or more embeddings based on the adjustments.

14. The system of claim 13, wherein encoding the modified tensor representation comprises:
obtaining a convolutional stem output based on the modified tensor representation;
scaling the convolutional stem output by a pooling factor; and
downsampling the scaled convolutional stem output based on a stride number.

15. The system of claim 12, wherein the channel in-painting comprises randomly setting one or more unlabeled data samples to zero.

16. The system of claim 11, wherein the latent representation has less dimensionality than the input tensor representation.

17. The system of claim 11, wherein the first machine learning network is pretrained using self-supervised learning.

18. The system of claim 11, wherein the one or more signal processing tasks comprise at least one of:
beamforming weight detection,
bandwidth regression,
blind channel detection,
signal detection from noise,
joint signal detection,
interference detection,
signal classification,
direction-of-arrival estimation, or
channel estimation.

19. The system of claim 11, wherein generating the input tensor representation of the plurality of data samples comprises:
obtaining, from the plurality of data samples, a plurality of data frames in a time domain;
performing a short-time Fourier transform (STFT) on the plurality of RF data frames to obtain a joint time-and-frequency-domain representation of the plurality of data samples; and
normalizing the joint time-and-frequency-domain representation of the plurality of data samples.

20. The system of claim 11, wherein the input tensor representation comprises at least one of:
a first dimension representing grouping of the plurality of unlabeled data samples,
a second dimension representing the one or more antenna channels,
a third dimension representing sampling times, or
a fourth dimension representing one or more quadrature channels.
